(19) United States
(12) Patent Application Publication
(10) Pub. No.: US 2014/0184511 A1
(43) Pub. Date: Jul. 3, 2014

(54) ACCURATE DATA ENTRY INTO A MOBILE COMPUTING DEVICE

(71) Applicant: Ismo Puustinen, Helsinki (FI)

(72) Inventor: Ismo Puustinen, Helsinki (FI)

(21) Appl. No.: 13/729,369

(22) Filed: Dec. 28, 2012

(51) Int. Cl. G06F 3/0488

(52) U.S. Cl. CPC G06F 3/04886
USPC 345/168

(57) ABSTRACT

Technologies for increased accuracy of data entry into a mobile computing device includes displaying a virtual keyboard on a display of the mobile computing device and receiving selection of a virtual key of the virtual keyboard using a key input mapping that is offset relative to the corresponding selected virtual key. For example, the key input mapping may be spatially displaced from the corresponding virtual key and/or have a surface area that is different from the corresponding virtual key. The key input mapping may be offset as a function of the handedness of use of the mobile computing device such that the amount of offset is non-uniform across the virtual keyboard.

### BACKGROUND

Mobile computing devices are becoming ubiquitous tools for personal, business, and social uses. The portability of mobile computing devices is increasing as the size of the devices decrease and processing power increases. In fact, many computing devices are sized to be hand-held by the user to improve ease of use. Additionally, modern mobile computing devices are equipped with increased processing power and data storage capability to allow such devices to perform advanced processing. Further, many modern mobile computing devices are capable of connecting to various data networks, including the Internet, to retrieve and receive data communications over such networks. As such, modern mobile computing devices are powerful, often personal, tools untethered to a particular location.

To facilitate portability, many mobile computing devices do not include hardware input devices such as a hardware keyboard or mouse. Rather, many modern mobile computing devices rely on the use of a virtual keyboard for data entry using, for example, a touchscreen display. The use of a virtual keyboard eliminates or reduces the need for a hardware keyboard, which may reduce the overall size of the mobile computing device. However, while the use of a virtual keyboard can reduce the size of the mobile computing device and increase portability, accurate data entry using a virtual keyboard can be difficult due to the size and location of virtual keys, the effects of parallax on the virtual keyboard, and user's tendency to utilize a single hand to operate the mobile computing device.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a mobile computing device for accurate data entry;

FIG. 2 is a simplified block diagram of at least one embodiment of an environment of the mobile computing device of FIG. 1;

FIG. 3 is a simplified illustration of at least one embodiment of a virtual keyboard and key input mapping of the mobile computing device of FIGS. 1 and 2;

FIG. 4 is a simplified illustration of at least one embodiment of a virtual keyboard and key input mapping of the mobile computing device of FIGS. 1 and 2;

FIG. 5 is a simplified flow diagram of one method for accurate data entry that may be executed by the mobile computing device of FIGS. 1 and 2; and

FIG. 6 is a simplified illustration of at least one embodiment of a display, having a virtual keyboard displayed thereon, of the mobile computing device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

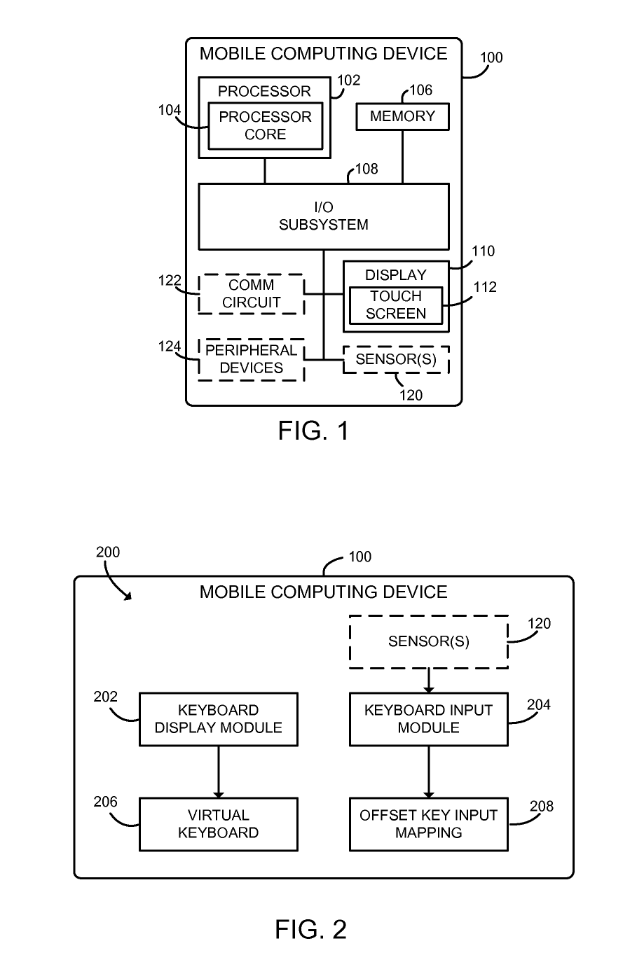

Referring now to FIG. 1, in one embodiment, a mobile computing device 100 configured for accurate data entry includes a display 110 having a touchscreen 112 to receive data entry from a user of the device. To do so, as discussed in more detail below, the mobile computing device 100 displays a virtual keyboard on the display 110 to facilitate data entry and/or selection by the user. The user's selection of the virtual keys of the virtual keyboard is detected utilizing a key input mapping for each corresponding virtual key. However, to improve the accuracy of the data entry (i.e., the accurate selection of intended virtual keys by the user), the individual key input mappings of one or more virtual keys are decoupled and offset from the corresponding virtual keys. Such offsetting of the key input mappings relative to the corresponding virtual keys may increase the accuracy of data entry by the user as discussed below.

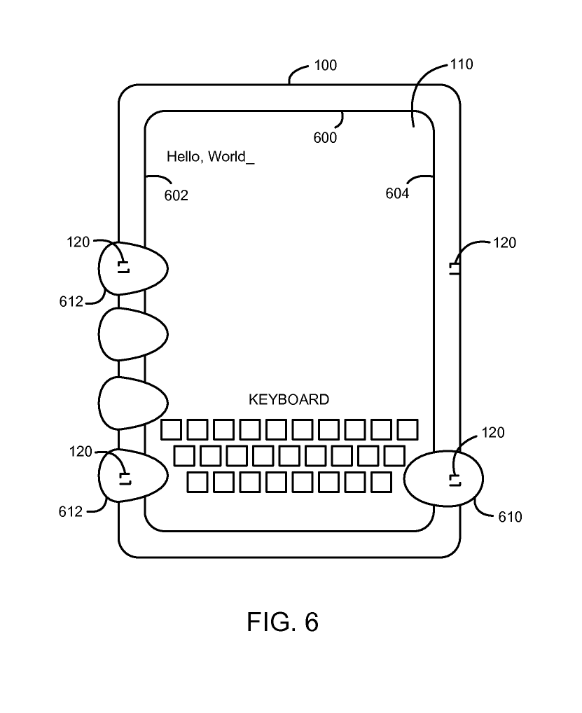

For example, as shown in FIG. 6, many users of mobile computing devices hold the mobile computing device in a single hand during operation and often utilize the thumb (or finger) of the holding hand to select the desired virtual keys during data entry and selection. However, due to the rather large size of the user's thumb relative to the virtual keys, the user's thumb may hide the desired virtual keys (especially those located on the opposite side of the virtual keyboard from the user's thumb), which increases the inaccuracy of virtual key selection. Additionally, the irregular shape of the user's thumb causes many users to inaccurately touch the touchscreen display when selecting a virtual key. In fact, it has been discovered that many users tend to select a spot on the touchscreen display that is slightly lateral to and upward from the desired virtual key. For example, assuming the user is holding the mobile computing device in his/her right hand, the user may accidently touch the touchscreen in a location that is to the left and above the desired virtual key. As such, by offsetting the individual key input mapping of one or more virtual keys of the virtual keyboard, the mobile computing device may more accurately detect selection of the desired virtual key by the user even when the user touches the touchscreen in a location offset from the intended virtual key.

The mobile computing device 100 may be embodied as any type of mobile computing device capable of performing the functions described herein. For example, in some embodiments, the mobile computing device 100 may be embodied as a “smart” phone, a tablet computer, a mobile media device, a game console, a mobile internet device (MID), a personal digital assistant, a laptop computer, a mobile appliance device, or other mobile computing device. As shown in FIG. 1, the illustrative mobile computing device 100 includes a processor 102, a memory 106, an input/output subsystem 107, and a display 110. Of course, the mobile computing device 100 may include other or additional components, such as those commonly found in a mobile computing and/or communication device (e.g., various input/output devices), in other embodiments. Additionally, in some embodiments, one or more of the illustrative components may be incorporated in, or otherwise from a portion of, another component. For example, the memory 106, or portions thereof, may be incorporated in the processor 102 in some embodiments.

The processor 102 may be embodied as any type of processor capable of performing the functions described herein. For example, the processor may be embodied as a single or multi-core processor(s) having one or more processor cores 104, a digital signal processor, a microcontroller, or other processor or processing/controlling circuit. Similarly, the memory 106 may be embodied as any type of volatile or non-volatile memory or data storage currently known or developed in the future and capable of performing the functions described herein. In operation, the memory 106 may store various data and software used during operation of the mobile computing device 100 such as operating systems, applications, programs, libraries, and drivers. The memory 106 is communicatively coupled to the processor 102 via the I/O subsystem 108, which may be embodied as circuitry and/or components to facilitate input/output operations with the processor 102, the memory 106, and other components of the mobile computing device 100. For example, the I/O subsystem 108 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 108 may form a portion of a system-on-a-chip (SoC) and be incorporated, along with the processor 102, the memory 106, and other components of the mobile computing device 100, on a single integrated circuit chip.

The display 110 of the mobile computing device may be embodied as any type of display on which information may be displayed to a user of the mobile computing device. Illustratively, the display 110 is a touchscreen display and includes a corresponding touchscreen sensor 112 to receive tactile input and data entry from the user. The display 110 may be embodied as, or otherwise use, any suitable display technology including, for example, a liquid crystal display (LCD), a light emitting diode (LED) display, a cathode ray tube (CRT) display, a plasma display, and/or other display usable in a mobile computing device. Similarly, the touchscreen sensor may use any suitable touchscreen input technology to detect the user's tactile selection of information displayed on the display 110 including, but not limited to, resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors.

In some embodiments, the mobile computing device 100 may also include one or more sensors 120 for detecting the handedness of use of the mobile computing device 100 by the user. That is, the sensors 120 are configured and usable to detect whether the user is holding the mobile computing device 100 in the user's left or right hand. To do so, the sensor(s) 120 may detect, for example, the placement of the user's hand on the case or housing of the mobile computing device 100, detect the location of the user's finger on the case or housing, detect the movement of the user's thumb or fingers, and/or the like. As such, the sensor(s) 120 may be embodied as any type of sensor capable of generating sensor signals from which the handedness of use of the mobile computing device 100 may be determined or inferred including, but not limited to, capacitive sensors, a proximity sensors, pressure sensors, light sensors, cameras, accelerometers, gyroscopes, and/or other sensors and/or sensing elements.

Additionally, in some embodiments, the mobile computing device 100 may include a communication circuit 122. The communication circuit 122 may be embodied as one or more devices and/or circuitry for enabling communications with one or more remote devices over a network. The communication circuit 122 may be configured to use any suitable communication protocol to communicate with remote devices over such network including, for example, cellular communication protocols, wireless data communication protocols, and/or wired data communication protocols.

In some embodiments, the mobile computing device 100 may further include one or more peripheral devices 124. Such peripheral devices 124 may include any type of peripheral device commonly found in a mobile computing device such as speakers, a hardware keyboard, input/output devices, peripheral communication devices, antennas, and/or other peripheral devices.

Referring now to FIG. 2, in one embodiment, the mobile computing device 100 establishes an environment 200 during operation. The illustrative environment 200 includes a keyboard display module 202 and a keyboard input module 204, each of which may be embodied as software, firmware, hardware, or a combination thereof. During use, the keyboard display module 202 generates a virtual keyboard 206, which is displayed on the display 110. The keyboard display module 202 may display the virtual keyboard 206 automatically or responsively. For example, the keyboard display module 202 may be configured to display the virtual keyboard 206 in response to actions taken by a user of the mobile computing device 100 (e.g., in response to the user's selection of a hardware button, activation of a software application, selection of a data entry widget, etc.) or in response to operation of an application executed on the mobile computing device 100.

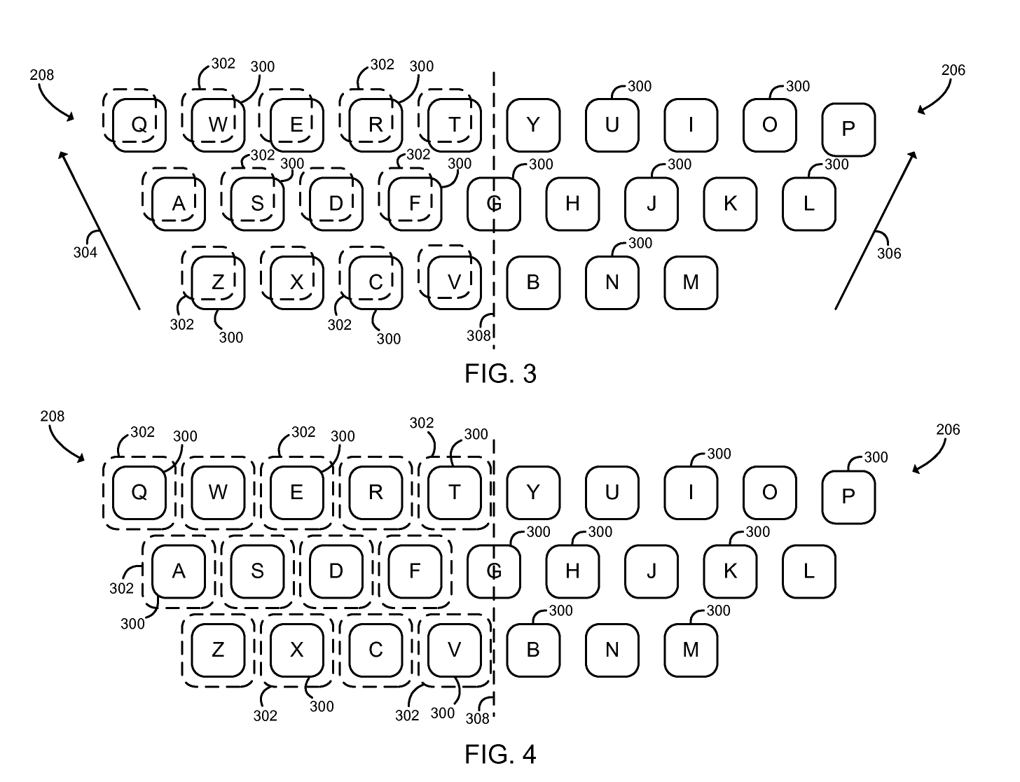

The virtual keyboard 206 may be embodied as any type of virtual or “soft” keyboard and includes one or more virtual keys. The virtual keyboard 206 may be similar to a generic, hardware keyboard and include a set of alphanumeric virtual keys, or may be embodied as a specialized virtual keyboard having a specialized selection of virtual keys (e.g., an application-specific virtual keyboard). One illustrative embodiment of a virtual keyboard 206 that may be generated and displayed by the keyboard display module 204 is shown in FIG. 3. The illustrative virtual keyboard 206 of FIG. 3 is similar to a traditional hardware keyboard in appearance and includes a plurality of virtual keys 300 that correspond to letters of the alphabet to facilitate data entry into the mobile computing device 100 by the user.

Referring back to FIG. 2, in use, the keyboard input module 204 generates a key input mapping 208, which is used by the keyboard input module 204 to receive selection of the virtual keys 300 of the virtual keyboard 206. In some embodiments, as discussed in more detail below, the key input mapping 208 is generated as a function of sensor signals received from the sensor(s) 120. That is, the keyboard input module 204 may generate the key input mapping 208 based on the handedness of use of the mobile computing device 100 by the user (i.e., whether the user is holding the mobile computing device 100 in his/her left or right hand). In other embodiments, the key input mapping 208 may be generated based on static or pre-selected criteria.

The key input mapping 208 defines the area of the touchscreen sensor 112 of the display 110 that may be touched by a user to select the corresponding virtual key 300. In a traditional virtual keyboard, the individual key input mappings are aligned with the corresponding virtual keys such that if a user “touches” the icon of the virtual key, the mobile computing device will interpret such touch to be a selection of the virtual key. However, the key input mapping 208 is different from a traditional key input mapping in that the key input mapping 208 includes one or more individual key input mappings 302 (see FIG. 3) of virtual keys 300 that are offset relative to the corresponding virtual keys 300. That is, not all of the individual key input mappings 302 are aligned with the corresponding virtual key 300. Rather, one or more individual key input mappings 302 are “misaligned” or otherwise offset relative to the corresponding virtual keys 300.

In some embodiments, the individual key input mappings 302 of the virtual keys 300 may be offset relative to the corresponding virtual keys 300 by spatially shifting an individual key input mapping 302 from the corresponding virtual key 300 such that the individual key input mapping and the corresponding virtual key 300 are not aligned over each other. For example, as shown in FIG. 3, an individual key input mapping 302 for the “W” key (illustrated in FIG. 3 with dashed lines along with other illustrative individual key input mappings 302), is spatially shifted relative to the corresponding virtual “W” key 300. In particular, because it has been determined that a typical user will contact the touchscreen 112 of the mobile computing device 100 at a location that is above and to the left of the desired virtual key 300 (assuming the mobile computing device 100 is being held in the user's right hand and the user is using his/her thumb to select the virtual key 300), the individual key input mapping 302 of FIG. 3 has been shifted toward a top side 600 and left side 602 (see FIG. 6) of the display 110 in a generally diagonal direction relative to the virtual keyboard 206 as indicated by arrow 304. Of course, if the user is holding the mobile computing device 100 in his/her left hand and operating the virtual keyboard 206 with his/her left thumb, the individual key input mappings 302 may be shifted toward the top 600 and right side 604 (see FIG. 6) of the display 110 in a generally diagonal direction relative to the virtual keyboard as indicated by arrow 306.

The individual virtual key mappings 302 may be spatially shifted by a uniform amount in some embodiments. Alternatively, in other embodiments, the amount of offset (i.e. the distance of spatial shift) of the individual virtual key mappings 302 may be non-uniform. For example, in some embodiments, only those virtual keys 300 located on the one-half side of the virtual keyboard 206 (illustratively delineated in FIG. 3 via vertical line 308) that is opposite of the user's thumb are offset by being spatially shifted. In the illustrative embodiment of FIG. 3, in which it is assumed the user is holding the mobile computing device 100 in the user's right hand, only the individual key input mappings 302 of those virtual keys 300 located on the left side of the virtual keyboard 206 are offset. Alternatively, in embodiments in which the user is holding the mobile computing device in his/her left hand, only the key input mappings of those virtual keys 300 located on the right side of the virtual keyboard 206 may be offset.

Additionally, in some embodiments, the amount of offset for each individual key input mapping 302 may be non-uniform. For example, the amount of offset for each individual key input mapping 302 may be a function of the distance of each virtual key from the user's thumb or other reference point (e.g., the amount of offset of the individual key input mapping 302 for the “Q” virtual key 300 may be greater than the amount of offset for the “V” virtual key 300). Further, in some embodiments, substantially all of the individual key input mappings 302 may be offset by some amount based on, for example, the location of the corresponding virtual key 300. For example, in the embodiment of FIG. 3, the individual key input mapping 302 for the “M” virtual key 300 may be slightly offset while the individual key input mapping 302 of the “Q” virtual key 300 may be offset by a greater amount.

In some embodiments, the individual key input mappings 302 may be offset relative to the corresponding virtual keys 300 by enlarging, or otherwise modifying, the area of the individual key input mapping 302 relative to the corresponding virtual key 300. For example, as shown in FIG. 4, each individual key input mapping 302 has a surface area that is greater than the corresponding virtual key 300. Additionally or alternatively, in some embodiments, the shape of each individual key input mapping 302 may be irregular relative to, or otherwise dissimilar to, the shape of the corresponding virtual key 300 (e.g., the individual key input mapping 302 may be oblong in the direction of arrow 304, 306). As discussed above, the amount of offset (i.e., the amount of increased surface area) of each individual key input mapping 302 may be uniform or non-uniform.

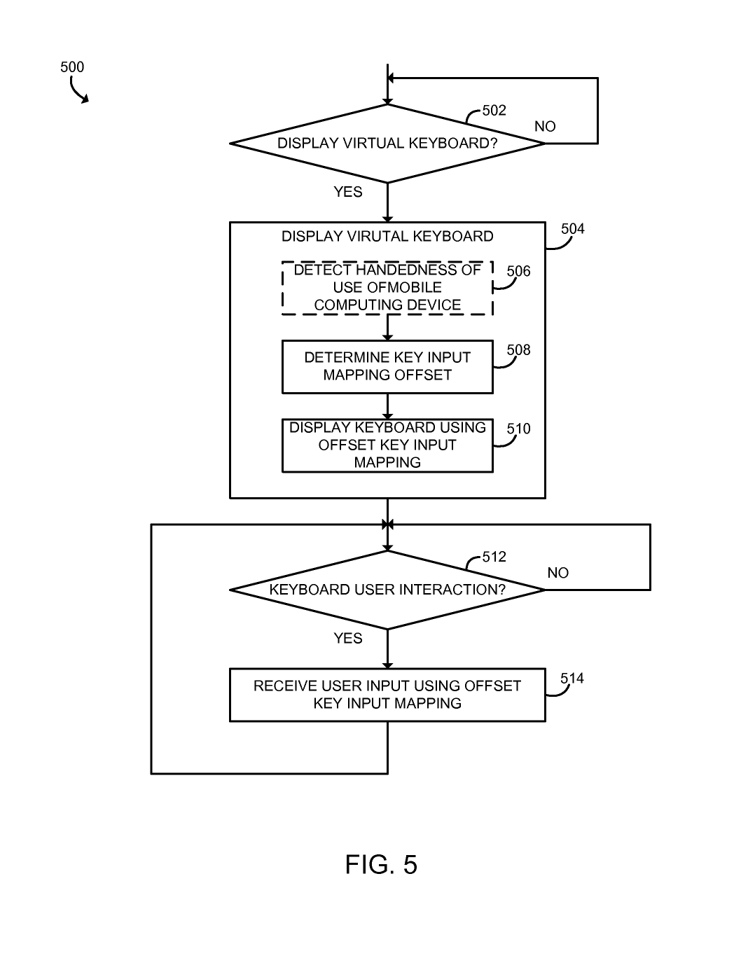

Referring now to FIG. 5, in use, the mobile computing device 100 may execute a method 500 for improving the accuracy of data entry on the mobile computing device 100. The method 500 begins with block 502 in which the mobile computing device 100 determines whether to display the virtual keyboard 206. For example, the mobile computing device 100 may display the virtual keyboard 206 in response to a user's request for the virtual keyboard 206, in response to a user's selection of a data entry widget (e.g., a data entry cell), in response to a request from another application running on the mobile computing device 100, or in response to some other criteria.

If the mobile computing device 100 determines that the virtual keyboard 206 should be displayed, the method 500 advances to block 504 in which the mobile computing device 100 displays the virtual keyboard 206 on the display 110. To do so, in some embodiments, the mobile computing device 100 detects, or otherwise determines, the handedness of use of the mobile computing device 100 by the user based on the signals received from the sensors 120 in block 506. For example, as shown in FIG. 6, the mobile computing device 100 may include a plurality of sensors 120 placed along the side of a housing of the mobile computing device 100 to detect the relative placement of the user's thumb 610 and fingers 612. Based on such information, the mobile computing device 100 can infer which hand of the user is likely holding the mobile computing device 100.

In block 508, the mobile computing device 100 determines the offset to be used with the key input mapping 208. For example, the mobile computing device 100 may determine the type of offset (e.g., spatial shift, area enlargement, etc.) and amount of offset (e.g., distance of spatial shift, size of area enlargement, etc.) to be used. In some embodiments, the offset to be used with the key input mapping 208 is preset. However, in other embodiments, the mobile computing device 100 is configured to determine the offset to be used with the key input mapping 208 based on the handedness of use of the mobile computing device 100 determined in block 506. For example, as discussed above in regard to FIGS. 3 and 4, the mobile computing device 100 may utilize a key input mapping 208 having individual key input mappings 302 that are spatially shifted in the direction of arrow 304 in response to determining the user is holding the mobile computing device 100 in the user's right hand. Conversely, the mobile computing device 100 may utilize a key input mapping 208 having individual key input mappings 302 that are spatially shifted in the direction of arrow 306 in response to determining the user is holding the mobile computing device 100 in the user's left hand. The determination of handedness of use in block 506 and the determination of the offset of the key input mapping 208 in block 508 may be performed substantially automatically and continually such that the key input mapping 208 changes in response to the user changing which hand is holding the mobile computing device 100.

After the offset to be used with the key input mapping 208 is determined in block 508, the mobile computing device 100 generates the key input mapping 208 and displays the virtual keyboard 206 in block 510. Subsequently, in block 512, the mobile computing device determines whether the user has interacted with the virtual keyboard 206 (e.g., whether the user has touched the touchscreen 112). If so, the user's selection of one or more virtual keys 300 is received using the offset key input mapping 208 in block 514. As discussed above, because the individual key input mappings 302 are offset from the corresponding virtual keys 300, the accuracy of data input by the user may be increased be detecting the user's selection of intended virtual keys 300 even when the user does not actually touch the area of the intended virtual key 300. The method 500 subsequently loops back to block 512 to monitor for additional interaction by the user.

### EXAMPLES

Illustrative examples of the devices, systems, and methods disclosed herein are provided below. An embodiment of the devices, systems, and methods may include any one or more, and any combination of, the examples described below.

Example 1 includes a mobile computing device for increased accuracy of data entry. The mobile computing device includes a touchscreen display; a keyboard display module to display a virtual keyboard on the touchscreen display, the virtual keyboard comprising a plurality of virtual keys; and a keyboard input module to generate a key input mapping having at least one key input mapping of a virtual key of the virtual keyboard that is offset relative to the corresponding virtual key.

Example 2 includes the subject matter of Example 1, and wherein the keyboard input module is to receive a tactile selection of the corresponding virtual key using the at least one key input mapping of the corresponding virtual key.

Example 3 includes the subject matter of any of Examples 1 and 2, and wherein the at least one key input mapping is offset toward (i) a top and (ii) a side of the touchscreen display relative to the corresponding virtual key.

Example 4 includes the subject matter of any of Examples 1-3, and wherein the at least one key input mapping has an area greater than the corresponding virtual key.

Example 5 includes the subject matter of any of Examples 1-, and wherein the key input mapping comprises a first subset of key input mappings of virtual keys that are each offset relative to a corresponding virtual key of the virtual keyboard and a second subset of key input mappings of virtual keys that are each not offset relative to a corresponding virtual key of the virtual keyboard.

Example 6 includes the subject matter of any of Examples 1-5, and wherein the first subset of key input mappings of virtual keys is located one half of the touchscreen display opposite the second subset of key input mappings.

Example 7 includes the subject matter of any of Examples 1-6, and wherein the keyboard input module is to further detect a handedness of use of the mobile computing device by a user of the mobile computing device and locate the first subset of key input mappings as a function of the determined handedness of use of the mobile computing device.

Example 8 includes the subject matter of any of Examples 1-7, and further including a sensor, and wherein detecting the handedness of use of the mobile computing device comprises detecting the handedness of use of the mobile computing device by the user as a function of a sensor signal received from the sensor.

Example 9 includes the subject matter of any of Examples 1-8, and wherein the keyboard input module is to further detect a handedness of use of the mobile computing device by a user of the mobile computing device and generate the key input mapping as a function of the detected handedness of use of the mobile computing device.

Example 10 includes the subject matter of any of Examples 1-9, and wherein to detect the handedness of use of the mobile computing device comprises to detect whether the user is holding the mobile computing device in the user's right hand, and wherein the key input mapping includes at least one key input mapping of a virtual key of the virtual keyboard that is offset toward (i) a top and (ii) a left side of the touchscreen display relative to the corresponding virtual key.

Example 11 includes the subject matter of any of Examples 1-10, and wherein to detect the handedness of use of the mobile computing device comprises to detect whether the user is holding the mobile computing device in the user's left hand, and wherein the key input mapping includes at least one key input mapping of a virtual key of the virtual keyboard that is offset toward (i) a top and (ii) a right side of the touchscreen display relative to the corresponding virtual key.

Example 12 includes the subject matter of any of Examples 1-11, and wherein the sensor comprises a sensor selected from the group consisting of: a capacitive sensor, a proximity sensor, a pressure sensor, a light sensor, and a camera.

Example 13 includes the subject matter of any of Examples 1-12, and wherein the key input mapping comprises a plurality of input key mappings of virtual keys that are each offset relative to the corresponding virtual key by a distance dependent upon the location of the corresponding virtual key on the virtual keyboard.

Example 14 includes a method for increasing the accuracy of data entry into a mobile computing device. The method includes displaying a virtual keyboard on a display of the mobile computing device, the virtual keyboard including a plurality of virtual keys; receiving a tactile selection of one of the plurality of virtual keys using a key input mapping of the selected virtual key that is offset relative to the selected virtual key.

Example 15 includes the subject matter of Example 14, and wherein receiving the tactile selection comprises receiving the tactile selection of the one of the plurality of virtual keys using a key input mapping of the selected virtual key that is offset toward (i) a top and a (ii) side of the display screen relative to the selected virtual key.

Example 16 includes the subject matter of any of Examples 14 and 15, and wherein receiving the tactile selection comprises receiving the tactile selection of the one of the plurality of virtual keys using a key input mapping of the selected virtual key that has an area greater than the selected virtual key.

Example 17 includes the subject matter of any of Examples 14-16, and wherein receiving the tactile selection comprises receiving the tactile selection using a key input mapping comprising a first subset of key input mappings of virtual keys that are each offset relative to a corresponding virtual key of the virtual keyboard and a second subset of key input mappings of virtual keys that are each not offset relative to a corresponding virtual key of the virtual keyboard.

Example 18 includes the subject matter of any of Examples 14-17, and further including detecting a handedness of use of the mobile computing device by a user of the mobile computing device, and generating, as a function of the detected handedness, a key input mapping for the virtual keyboard that includes the key input mapping of the selected virtual key.

Example 19 includes the subject matter of any of Examples 14-18, and wherein detecting the handedness of use of the mobile computing device comprises detecting that the user is holding the mobile computing device in the user's right hand, and wherein generating the key input mapping comprises generating a key input mapping of the selected virtual key that is offset toward (i) a top and (ii) a left side of the display screen relative to the selected virtual key.

Example 20 includes the subject matter of any of Examples 14-19, and wherein detecting the handedness of use of the mobile computing device comprises detecting that the user is holding the mobile computing device in the user's left hand, and wherein generating the key input mapping comprises generating a key input mapping of the selected virtual key that is offset toward (i) a top and (ii) a right side of the display screen relative to the selected virtual key.

Example 21 includes the subject matter of any of Examples 14-20, and wherein generating the key input mapping comprises generating a key input mapping having a subset of key input mappings that are each offset relative to a corresponding virtual key and each corresponding virtual key is located on the same one-half side of the virtual keyboard.

Example 22 includes the subject matter of any of Examples 14-21, and wherein detecting the handedness of the use of the mobile computing device comprises determining a location of a thumb of the user the user is using to supply the tactile selection, and wherein generating the key input mapping comprises generating a key input mapping having a subset of key input mappings of virtual keys that are each offset relative to a corresponding virtual key, wherein each corresponding virtual key is located on the same one-half side of the virtual keyboard that is located opposite the location of the thumb of the user.

Example 23 includes the subject matter of any of Examples 14-22, and wherein detecting the handedness of use of the mobile computing device comprises detecting the handedness of use of the mobile computing device as a function of sensor signals generated by at least one of: a capacitive sensor, a proximity sensor, a pressure sensor, a light sensor, and a camera.

Example 24 includes one or more machine readable storage media comprising a plurality of instructions stored thereon that in response to being executed result in a mobile computing device displaying a virtual keyboard on a touchscreen display of the mobile computing device, the virtual keyboard including a plurality of virtual keys; generating a key input mapping including a key input mapping of a first virtual key of the virtual keyboard that is offset relative to the first virtual key; and receiving a tactile selection of the first virtual key using the key input mapping of the first virtual key.

Example 25 includes the subject matter of Example 24, and wherein generating the key input mapping comprises generating a key input mapping including a key input mapping of the first virtual key that is offset toward (i) a top and (ii) a side of the touchscreen display relative to the first virtual key.

Example 26 includes the subject matter of any of Examples 24 and 25, and wherein generating the key input mapping comprises generating a key input mapping including a key input mapping of the first virtual key that has an area greater than the first virtual key.

Example 27 includes the subject matter of any of Examples 24-26, and wherein generating the key input mapping comprises generating a key input mapping having a first subset of key input mappings of virtual keys that are each offset relative to a corresponding virtual key of the virtual keyboard and a second subset of key input mappings of virtual keys that are each not offset relative to a corresponding virtual key of the virtual keyboard.

Example 28 includes the subject matter of any of Examples 24-27, and wherein the plurality of instructions further result in the mobile computing device detecting a handedness of use of the mobile computing device by a user of the mobile computing device, and wherein generating the key input mapping comprises generating the key input mapping as a function of the detected handedness.

Example 29 includes the subject matter of any of Examples 24-28, and wherein detecting the handedness of use of the mobile computing device comprises detecting that the user is holding the mobile computing device in the user's right hand, and wherein generating the key input mapping comprises generating a key input mapping including a key input mapping of the first virtual key that is offset toward (i) a top and (ii) a left side of the touchscreen display relative to the first virtual key.

Example 30 includes the subject matter of any of Examples 24-29, and wherein detecting the handedness of use of the mobile computing device comprises detecting that the user is holding the mobile computing device in the user's left hand, and wherein generating the key input mapping comprises generating a key input mapping including a key input mapping of the first virtual key that is offset toward (i) a top and (ii) a right side of the touchscreen display relative to the first virtual key.

Example 31 includes the subject matter of any of Examples 24-30, and wherein generating the key input mapping comprises generating a key input mapping having a subset of key input mappings that are each offset relative to a corresponding virtual key and each corresponding virtual key is located on the same one-half side of the virtual keyboard.

Example 32 includes the subject matter of any of Examples 24-31, and wherein detecting the handedness of the use of the mobile computing device comprises determining a location of a thumb of the user the user is using to supply the tactile selection, and wherein generating the key input mapping comprises generating a key input mapping having a subset of key input mappings of virtual keys that are each offset relative to a corresponding virtual key, wherein each corresponding virtual key is located on the same one-half side of the virtual keyboard that is located opposite the location of the thumb of the user.

Example 33 includes the subject matter of any of Examples 24-32, and wherein detecting the handedness of use of the mobile computing device comprises detecting the handedness of use of the mobile computing device as a function of sensor signals generated by at least one of: a capacitive sensor, a proximity sensor, a pressure sensor, a light sensor, and a camera.

1. A mobile computing device for increased accuracy of data entry, the mobile computing device comprising:
a touchscreen display;
a keyboard display module to display a virtual keyboard on the touchscreen display, the virtual keyboard comprising a plurality of virtual keys; and
a keyboard input module to generate a key input mapping having at least one key input mapping of a virtual key of the virtual keyboard that is offset relative to the corresponding virtual key.

2. The mobile computing device of claim 1, wherein the keyboard input module is to receive a tactile selection of the corresponding virtual key using the at least one key input mapping of the corresponding virtual key.

3. The mobile computing device of claim 1, wherein the at least one key input mapping is offset toward (i) a top and (ii) a side of the touchscreen display relative to the corresponding virtual key.

4. The mobile computing device of claim 1, wherein the at least one key input mapping has an area greater than the corresponding virtual key.

5. The mobile computing device of claim 1, wherein the key input mapping comprises a first subset of key input mappings of virtual keys that are each offset relative to a corresponding virtual key of the virtual keyboard and a second subset of key input mappings of virtual keys that are each not offset relative to a corresponding virtual key of the virtual keyboard.

6. The mobile computing device of claim 5, wherein the first subset of key input mappings of virtual keys is located one half of the touchscreen display opposite the second subset of key input mappings.

7. The mobile computing device of claim 1, wherein the keyboard input module is to further detect a handedness of use of the mobile computing device by a user of the mobile computing device and generate the key input mapping as a function of the detected handedness of use of the mobile computing device.

8. The mobile computing device of claim 1, wherein the key input mapping comprises a plurality of input key mappings of virtual keys that are each offset relative to the corresponding virtual key by a distance dependent upon the location of the corresponding virtual key on the virtual keyboard.

9. A method for increasing the accuracy of data entry into a mobile computing device, the method comprising:
displaying a virtual keyboard on a display of the mobile computing device, the virtual keyboard including a plurality of virtual keys; and
receiving a tactile selection of one of the plurality of virtual keys using a key input mapping of the selected virtual key that is offset relative to the selected virtual key.

10. The method of claim 9, wherein receiving the tactile selection comprises receiving the tactile selection of the one of the plurality of virtual keys using a key input mapping of the selected virtual key that is offset toward (i) a top and a (ii) side of the display screen relative to the selected virtual key.

11. The method of claim 9, wherein receiving the tactile selection comprises receiving the tactile selection of the one of the plurality of virtual keys using a key input mapping of the selected virtual key that has an area greater than the selected virtual key.

12. The method of claim 9, wherein receiving the tactile selection comprises receiving the tactile selection using a key input mapping comprising a first subset of key input mappings of virtual keys that are each offset relative to a corresponding virtual key of the virtual keyboard and a second subset of key input mappings of virtual keys that are each not offset relative to a corresponding virtual key of the virtual keyboard.

13. The method of claim 9, further comprising:
detecting a handedness of use of the mobile computing device by a user of the mobile computing device, and
generating, as a function of the detected handedness, a key input mapping for the virtual keyboard that includes the key input mapping of the selected virtual key.

14. The method of claim 13, wherein detecting the handedness of the use of the mobile computing device comprises determining a location of a thumb of the user the user is using to supply the tactile selection, and
wherein generating the key input mapping comprises generating a key input mapping having a subset of key input mappings of virtual keys that are each offset relative to a corresponding virtual key, wherein each corresponding virtual key is located on the same one- half side of the virtual keyboard that is located opposite the location of the thumb of the user.

15. One or more machine readable storage media comprising a plurality of instructions stored thereon that in response to being executed result in a mobile computing device:
displaying a virtual keyboard on a touchscreen display of the mobile computing device, the virtual keyboard including a plurality of virtual keys;
generating a key input mapping including a key input mapping of a first virtual key of the virtual keyboard that is offset relative to the first virtual key; and
receiving a tactile selection of the first virtual key using the key input mapping of the first virtual key.

16. The one or more machine readable storage media of claim 15, wherein generating the key input mapping comprises generating a key input mapping including a key input mapping of the first virtual key that is offset toward (i) a top and (ii) a side of the touchscreen display relative to the first virtual key.

17. The one or more machine readable storage media of claim 15, wherein generating the key input mapping comprises generating a key input mapping including a key input mapping of the first virtual key that has an area greater than the first virtual key.

18. The one or more machine readable storage media of claim 15, wherein the plurality of instructions further result in the mobile computing device detecting a handedness of use of the mobile computing device by a user of the mobile computing device, and wherein generating the key input mapping comprises generating the key input mapping as a function of the detected handedness.

19. The one or more machine readable storage media of claim 18, wherein detecting the handedness of use of the mobile computing device comprises detecting that the user is holding the mobile computing device in the user's right hand, and
wherein generating the key input mapping comprises generating a key input mapping including a key input mapping of the first virtual key that is offset toward (i) a top and (ii) a left side of the touchscreen display relative to the first virtual key.

20. The one or more machine readable storage media of claim 18, wherein detecting the handedness of use of the mobile computing device comprises detecting that the user is holding the mobile computing device in the user's left hand, and
wherein generating the key input mapping comprises generating a key input mapping including a key input mapping of the first virtual key that is offset toward (i) a top and (ii) a right side of the touchscreen display relative to the first virtual key.
